(19) United States
(12) Patent Application Publication
(10) Pub. No.: US 2005/0040820 A1
(43) Pub. Date: Feb. 24, 2005

(54) Method and system for acquiring spin labeled images by means of adiabatic flow critterion

(76) Inventors: Johannes Jacobus Van Vaals, Eindhoven (NL); Johan Samuel Van Den Brink, Eindhoven (NL)

Correspondence Address: Thomas M Lundin;Philips Intellectual Property & Standards, 595 Miner Road, Cleveland, OH, 44143, US

(21) Appl. No.: 10/496,089

(22) PCT Filed: Nov. 20, 2002
(86) PCT No.: PCT/IB02/04874

(30) Foreign Application Priority Data
Nov. 23, 2001 (EP) 01204527.4

(51) Int. Cl. G01V 3/00

(52) U.S. Cl. 324/306; 324/303

(57) ABSTRACT

The invention relates to a method of adiabatic flow labeling and a system to facilitate the method. The system comprises a MR-apparatus 20 and dedicated labeling means, for example an interventional catheter 50 equipped with an RF-transmit coil and magnetic means for inducing a local stationary magnetic gradient field in a volume comprising said RF-transmit coil.

The invention relates to a method of acquiring spin labeled images of an imaging volume of a vessel, said imaging volume comprising substantially stationary and substantially moving substances, the method comprising the steps of
performing a magnetic labeling of spins of the moving substance in the vessel in a volume upstream of the imaging volume, the magnetic labeling being preformed by means of an adiabatic flow criterion;
allowing time for the thus formed spin labeled moving substance to flow into said imaging volume;
performing the acquisition of the thus formed first spin labeled image in a plane comprising stationary and moving substances in the imaging volume.

The invention further relates to a system for performing an acquisition of spin labeled images of an imaging volume in a vessel.

The invention still further relates to a magnetic resonance imaging probe to be used in said system.

The invention relates to the field of arterial spin labeling techniques. In practice most often contrast media are used in order to perform perfusion studies and angiographic imaging by means of magnetic resonance imaging. One of the known techniques to visualize the blood flow in vessels uses endogenous water as contrast medium, and is referred to as an arterial spin labeling, Dixon et al ‘Projection angiograms of blood labeled by adiabatic fast passage’, Magnetic Resonance in Medicine 3, 454-462 (1986), which is incorporated herewith by reference. The adiabatic flow criterion is defined as
H1/D<<G<<H1²/V, where
H1 is a value of a RF-field strength
G is a value of a magnetic field gradient
D is a length of a RF-transmit coil
V is the blood velocity.

According to the procedure of spin labeling according to the adiabatic flow criterion the spins of water hydrogen of the blood are inverted upstream of the imaging volume. When thus spin-inverted blood reaches the imaging volume it serves as an intrinsic contrast medium.

The advantage of this technique with respect to the commonly utilized exogenous contrast media is explained by the fact that the natural substances of the recipient are being hereby used as a contrast medium with transient contrast enhancement characteristics, which imposes no limitations with respect to the repetition rate of the study.

An embodiment of a method and a system as described in the opening paragraph is described by G. Zaharchuk et al ‘Multislice perfusion and perfusion territory imaging in humans with separate label and image coils’, Magnetic Resonance in Medicine, 41: 1093-1098 (1999). In the known method a surface RF-transmit coil is used in combination with a general purpose magnetic resonance apparatus. The surface RF-transmit coil is positioned on a skin of the patient above the vessel of interest upstream the imaging volume in order to perform adiabatic arterial blood labeling. The necessary magnetic field gradients for purposes of magnetic spin labeling are generated by the gradient coils of the magnetic imaging apparatus. The disadvantage of the known method lies in a low efficiency of imaging, as image acquisition can be only performed in the time intervals that are free from magnetic spin labeling for which long time intervals in the order of 2 seconds are required.

It is an object of the invention to provide a relatively efficient method of acquiring high quality spin labeled images of an imaging volume in a vessel.

This is achieved by the method according to the invention characterized in that the magnetic labeling is performed wit dedicated magnetic labeling means invasively in a substantially continuous mode. As is apparent to a person skilled in the art, positioning of the magnetic labeling means invasively, for example by mounting them on an interventional catheter, can provide the constant and continuous inversion of the magnetization spins of the blood in a volume around the magnetic labeling means without any temporal interference with the image acquisition hard-ware of the magnetic resonance apparatus. This insight is based on the fact that in order to perform the magnetic spin labeling according to the adiabatic flow criterion, next to an emission of a RF-field a local gradient of the magnetic field has to be created in a labeling volume. By utilizing the dedicated magnetic labeling means, comprising necessary hardware for that purpose, the hard-ware of the magnetic resonance apparatus, such as field gradient coils, required for a definition of the imaging slice can be relieved. With the dedicated magnetic labeling means it is also possible to perform efficient spin labeling even in a semi-continuous mode or in a pulsed mode, because the allowable intervals in the data acquisition will still be much less that several seconds, known from the state of the art. Due to the fact that the interventional catheter is brought close to the vessel of interest, the transit time is largely reduced and the enhancement is high. This is an advantageous feature for performing territorially selective angiographic studies of, for example the middle cerebral artery of the circle of Willis. Therefore, when the inverted blood arrives at an imaging volume located downstream of the labeling means, the image acquisition of the imaging volume can be performed by the available hardware of the MR-apparatus without interruptions for spin labeling purposes. When the magnetic labeling means are operating in a continuous mode, the image data acquisition can be performed also in a continuous mode after a first time delay has elapsed providing for the inflow of the labeled blood into the imaging volume. Therefore, the acquisition of high-quality spin labeled images can be performed efficiently.

An embodiment of the method according to the invention is characterized in that said method further comprising the steps of:
making a control image of the imaging volume without spin labeling;
subtracting the image data of the spin labeled image from the control image.

In order to obtain perfusion images, the data of the spin labeled and control image sets has to be subtracted. A method to perform perfusion images is known per se and is given in U.S. Pat. No. 6,271,665. The control image according to the method according to the invention is acquired when no spin inversion of the blood has taken place. For that purposes the spin labeling means can be deactivated and the regular image acquisition of the imaging volume is performed. It is also possible to perform control image acquisition prior to positioning of the invasive spin labeling means in the vicinity of the imaging volume. The perfusion method according to the invention has advantages over the known method, as it gives a possibility for the continuous high-quality imaging.

A system for performing an acquisition of spin labeled images of an imaging volume in a vessel comprises a magnetic resonance apparatus and magnetic labeling means to perform a magnetic labeling of spins of a moving substance in the vessel in a volume upstream of the imaging volume, the magnetic labeling being performed by means of an adiabatic flow criterion. The system according to the invention is characterized in that the magnetic labeling means are dedicated invasive means.

An embodiment of the system according to the invention is characterized in that the invasive magnetic labeling means comprise an elongated magnetic resonance imaging probe, said probe to be introduced in the vessel said magnetic resonance imaging probe comprises an RF-transmit coil and further magnetic means arranged for inducing a local stationary magnetic gradient field in a volume comprising said RF-transmit coil, said gradient field being substantially parallel to a longitudinal direction of the magnetic resonance imaging probe. For example. in an interventional MR-setting, a catheter can be equipped with a small RF-transmit coil. There is a certain freedom in choosing the operational parameters for such an invasive spin labeling means, provided they satisfy the equation for adiabatic flow criterion, given above. For example, for typical blood velocities of v<<1 m/s, for a RF-coil with dimensions of 1 or 2 cm and the induced RF-field of 20 μT a sufficient local gradient of the magnetic field is 2 mT/m. Therefore, by means of such invasive spin labeling means operating in accordance with the adiabatic flow criterion, a very local labeling can be obtained at a very low RF deposition. Due to the fact that the interventional catheter is brought close to the vessel of interest, the transit time is largely reduced and the enhancement is high. The typical value for the blood flow in the circle of Willis is about 0.5 m/s. Thus for a RF-field of 10 μT it is sufficient to induce a local gradient of the magnetic field in the order of 2 mT/m. The adiabatic flow criterion requires a relatively low gradient filed, with optimal directionality along the blood flow direction, which can be easily implemented using an interventional catheter. Therefore, such gradient inducing means will not produce an excessive torque on the catheter in a stationary magnetic field. Obviously, the catheter has to be introduced in the vessel of interest in such a way, that the labeling occurs in the volume upstream to the imaging volume.

An embodiment of the magnetic resonance imaging probe according to the invention is characterized in that the further magnetic means comprise at least one permanent magnet. A catheter comprising magnetic means and a RF-coil is known per se from WO 01/42807. The known catheter is arranged so that to perform a complete stand-alone MR-acquisition. The magnetic means of the known catheter comprise permanent magnets to induce a gradient field in a transverse direction to the blood flow. Such a catheter cannot be utilized to perform spin labeled images according to the adiabatic flow criterion.

In the magnetic imaging probe according to the invention it is sufficient to use a single permanent magnet in the vicinity of the RF-transfer coil. A fringe field is created by the single permanent magnet and can be used for labeling purposes. This fringe field has an effect of the gradient magnetic field and satisfies the equation for the adiabatic flow criterion. It is also possible to use two magnets of different magnetic strength surrounding the RF-transmit coil for better spatial alignment of the thus induced magnetic gradient field and the direction of the blood flow in the vessel.

A further embodiment of the magnetic resonance imaging probe according to the invention is characterized in that the further magnetic means comprise a material having a magnetic susceptibility that is substantially different from a magnetic susceptibility of a surrounding medium in the vessel. By placing a material having a different magnetic susceptibility than blood in the vicinity of the RF-transmit coil a very local focusing of the primary magnetic field B₀ can be achieved. This will cause a small gradient field along the catheter, which is sufficient for the spin labeling according to the adiabatic flow criterion. Possible examples of such material are metals from the lanthanides and actinides groups, their oxides and different legations. Also, long-lived triplet-molecules, such as O2 are well suited for these purposes. Next to these, air bubbles purposefully captured in the body of the catheter in the vicinity or around the RF-transmit coil can be used for the purpose of inducing a very local gradient of the magnetic field.

A further embodiment of the magnetic resonance imaging probe is characterized in that the magnetic resonance imaging probe further comprises an RF-receive coil, arranged to receive an imaging signal emanating from the imaging volume and located distally from the RF-transmit coil in the longitudinal direction of said magnetic resonance imaging probe. It is understood to be advantageous to position the RF-receive coil on the interventional catheter for an improved signal to noise ratio.

These and other aspects of the invention will be explained in greater detail with reference to figures, where corresponding numerals represent corresponding elements.

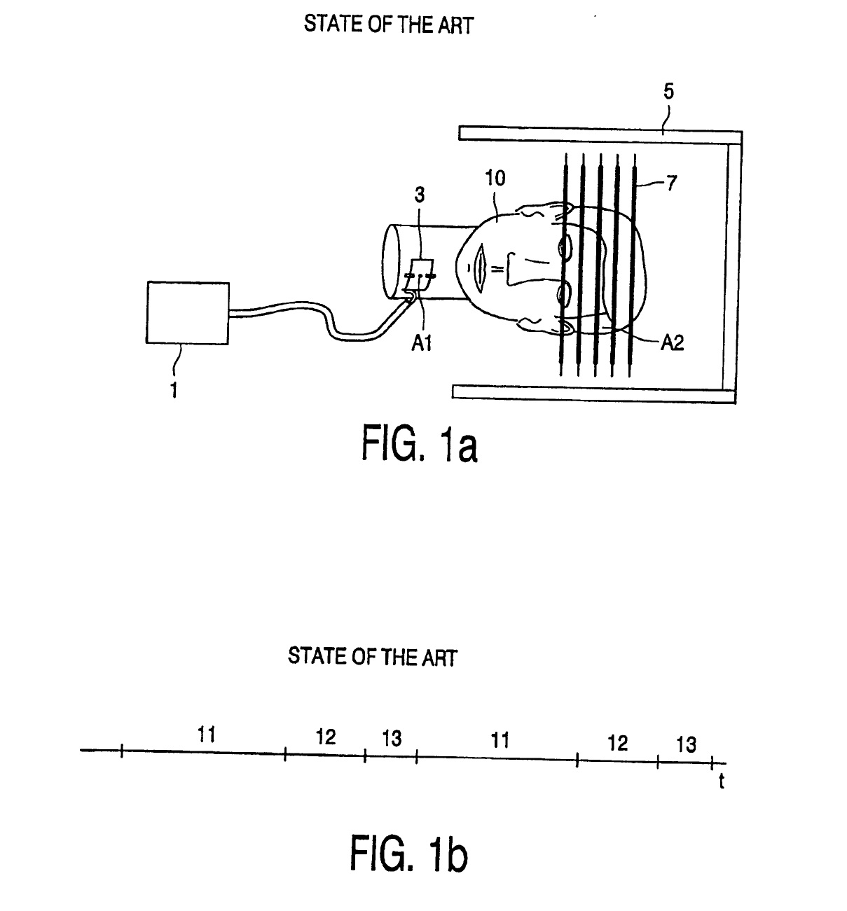

FIG. 1a presents a schematic representation of a system to perform spin labeling, known from the state of the art.

FIG. 1b presents a schematic representation of an image acquisition sequence, known from the state of the art.

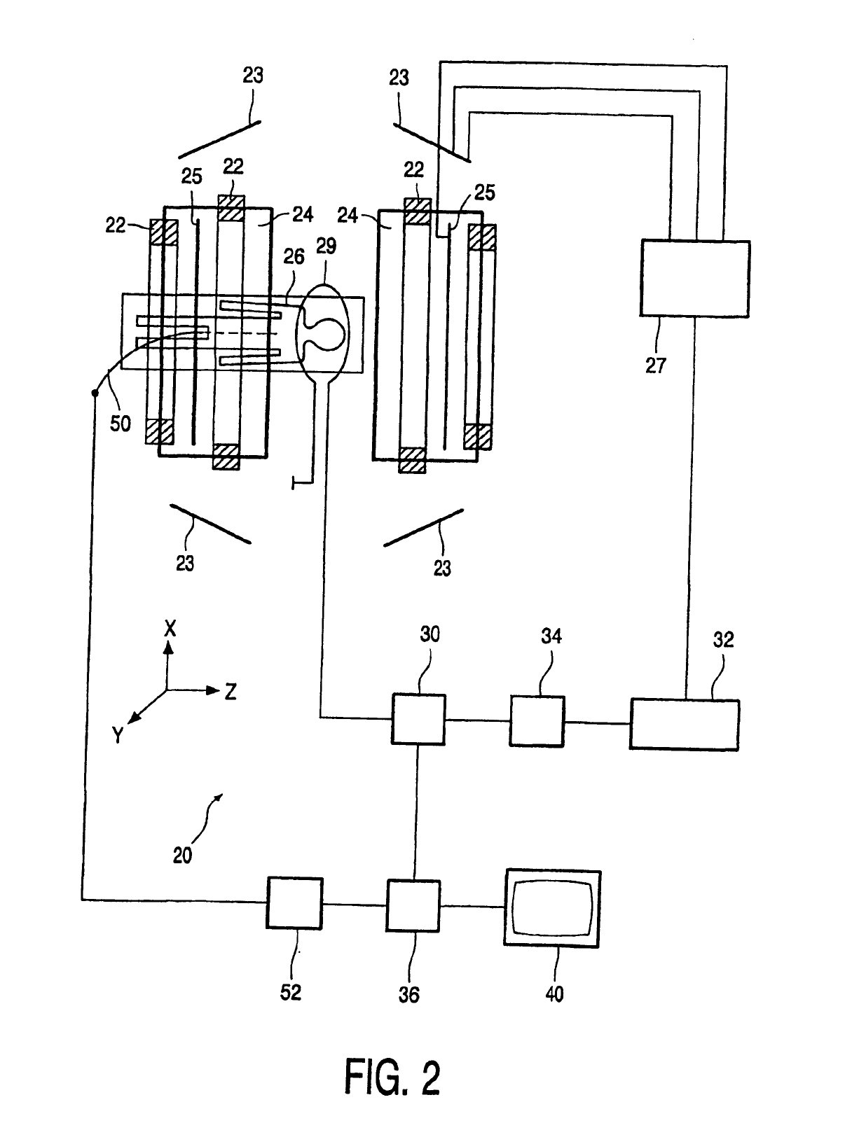

FIG. 2 presents a schematic representation of the system according to the invention.

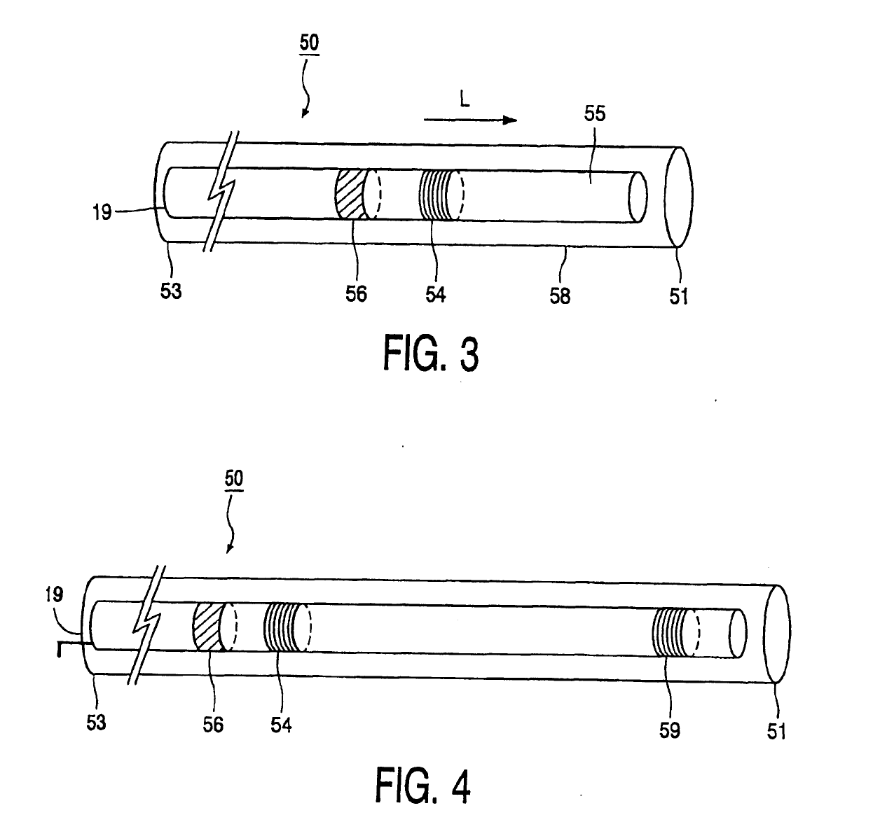

FIG. 3 presents a schematic view of a first embodiment of a magnetic resonance probe according to the invention.

FIG. 4 presents a schematic view of a second embodiment of the magnetic resonance probe according to the invention.

A system and an image acquisition sequence known from the state of the art are given in FIG. 1a and FIG. 1b, respectively. The known system comprises a magnetic resonance apparatus (not shown in the figure), where a patient 10 can be positioned for perfusion studies by means of spin labeling according to adiabatic flow criterion. The known system is arranged to perform the inversion of the blood spins in the volume A1 upstream to the volume under investigation A2. In order to perform spin labeling a surface RF-transmit coil 3 is positioned on a skin of the patient next to the volume A1 corresponding to the left carotid artery. In order to perform the spin labeling the RF-transmit coil, controlled by a control unit 1, emits RF-waves during a period of time defined by the pulse sequence software. This period of time is schematically illustrated by numerical 11 in FIG. 1b. After a predetermined period of labeling has elapsed the labeling RF-coil 3 is detuned. The acquisition software allows for a post-labeling delay 12, given in FIG. 1b, in order for the labeled portion of blood to reach the target volume A2, after which the acquisition of the slices 7 in the target volume can take place, see also 13, FIG. 1b. As is apparent from FIGS. 1a and 1b, the known system has a low efficiency, as labeling, delaying and data acquisition are performed in a temporal sequence and the time spent for the data acquisition is short in comparison with the labeling and delaying periods leading to unnecessary time losses.

An improved system for performing a spin labeling according to the adiabatic flow criterion according to the invention is given in FIG. 2. The magnetic resonance apparatus 20 comprises a first magnet system 22 for generating a static magnetic field. The Z direction of the coordinate system shown corresponds by convention to the direction of the static magnetic field in the magnet system 22. The magnetic resonance imaging apparatus 20 also includes several gradient coils, 23, 24, 25 for generating additional magnetic fields having gradient in the X, the Y, and the Z direction. The gradient coils 23,24,25 are fed by a power supply 27. The magnet system 22 encloses the examination space which is large enough to accommodate a part of an object to be examined, for example a patient 26. A RF-transmitter coil 29 is arranged around or on a part of the patient 26 in the examination space in order to emit excitation pulses. There is also provided a receiving coil (not shown), which is connected to a signal amplifier and demodulation unit 10 via the transmission/receiving circuit 30. A control unit 32 controls the modulator 34 and the power supply 27 in order to generate special pulse sequences for image acquisition. After the pulses generated in the patient body as a response to the RF-excitation pulses are detected by the receiving coil, the information is processed by the processing unit into an image data by means of transformation. This image can be displayed, for example on a monitor 40. FIG. 1 also shows a catheter 50 as an example of the magnetic resonance imaging probe, which is to be positioned within the patient 26 for magnetic spin labeling purposes. An example of the catheter 50 is being controlled by a control unit 52. The catheter is shown in greater detail in FIG. 3, where the magnetic labeling means are shown in greater detail as well. It must be understood that a hollow flow catheter can be also used as the catheter 50. In this case the substance to be labeled flows within the RF-coil through the volume of the catheter.

In order to perform magnetic spin labeling of the blood according to the invention, the system of FIG. 2 operates as follows. Upon the insertion of the catheter to a predetermined dwell position, the spin labeling of the blood can be performed. The magnetic labeling means arranged on the catheter are operated by the control unit 52 in order to satisfy to the adiabatic flow criterion. In case the control unit 52 supplies a continuous signal to the magnetic labeling means of the catheter 50 the magnetic labeling is performed continuously and without interference with the field gradient coils 23,24,25 of the magnetic resonance apparatus. Therefore, the acquisition of the imaging slices 7 of the target volume A2 of the patient can be performed using the gradient coils 23,24,25 independently of the operation of the magnetic resonance means arranged on the catheter 50.

FIG. 3 presents a schematic view of a first embodiment of a magnetic resonance probe according to the invention. The catheter 50 is to be inserted into a vessel under investigation, whereby the longitudinal direction L of the catheter 50 is substantially parallel to the direction of the blood flow in the vessel. The catheter 50 is provided with an RF-transmit coil 54 to transmit radio frequency waves in a volume around the catheter. A typical value for the length of a RF-transmit coil for labeling purposes according to the adiabatic flow criterion is in the range of 1 or 2 cm. According the method of the invention an independent weak stationary magnetic field gradient must be induced in the vicinity of the RF-transmit coil. This is achieved in the catheter 50 by means of a single permanent magnet 56, located in the vicinity of the RF-coil. The orientation of the magnet is chosen in such a way that the direction of the field gradient is substantially aligned along the longitudinal direction L of the catheter 50. The RF-transmit coil 54 is connected by means of electric connection 19 to the control unit 52, which controls the strength and, if necessary, the duration of the RF-pulses. In the simplest embodiment the RF-pulses are given continuously, enabling the continuous spin labeling leading to a continuous image acquisition of the target volume A2. The catheter 50 comprises further an envelope 58, having a distal end 51 and a proximal end 53. The catheter can be introduced by means of the distal end into the blood vessel of a patient. The RF-coil 54 is arranged near the distal end 51. The catheter 50 comprises further a carrier 55. The carrier 55 contains a flexible material, for example a synthetic material and can be constructed as a hollow tube. Typical diameters of the carrier 55 lye between 0.3 and 3 mm and its length amounts to, for example 110 cm to 150 cm.

Using suitably chosen RF-pulses and local magnetic gradient fields implemented by the assembly 54,56 the spin labeling according to the adiabatic flow criterion can be performed. For the continuous wave RF-pulses no pulse design is required, which further contributes to the simplification of the procedure. It must be noted that it is possible to induce the local magnetic gradient field in a vessel by other means. For example, for a better delineation between the direction of the field gradient and the blood flow, two separate permanent magnets, for example of different magnetic strengths can be used, arranged to induce a field gradient in the longitudinal direction of the catheter 50 in the vicinity of the RF-transmit coil 54. It must be understood that due to the fact that very weak magnetic gradients are sufficient for the purposes of the adiabatic flow labeling, no excessive torque will be induced. Also, it is possible to utilize a catheter with integrated materials therein having a different magnetic susceptibility than blood for inducing a very low magnetic field gradient. For example, one can utilize a dysprosium oxide or air bubbles intentionally captured in the body of the catheter around or in the vicinity of the RF-transmit coil 54. Also in this case no excessive torque is induced.

FIG. 4 shows another embodiment of the magnetic resonance imaging probe. The interventional catheter 50 comprises further a RF-receive coil 59, arranged distally with respect to the RF-transmit coil 54. Using this technical arrangement it is possible to perform image acquisition with such a catheter. It has to be noted, that in this case, the distance between the RF-transmit and RF-receive coil must be sufficiently large in order to allow both labeling and image acquisition without unnecessary signal interference. A typical distance between the RF-transmit and the RF-receive coils for cranial applications lies in the order of 20 cm. Thus, while the imaging slices are defined by the magnetic resonance apparatus, the resonance signal from spins within a volume near the RF coil 59 is received by the RF-receive coil 59. This embodiment allows for a good imaging of blood vessels, where the signal to noise ratio is enhanced. The received magnetic resonance signal is further processed in the processing unit, not shown in the figure, where the image transformation is taking place.

Those skilled in the art will readily appreciate that various modifications and changes can be applied to the preferred embodiments of the invention as hereinbefore exemplified without departing from its scope.

1. A method of acquiring spin labeled images of an imaging volume of a vessel, said imaging volume comprising substantially stationary and substantially moving substances, the method comprising the steps of:
performing a magnetic labeling of spins of the moving substance in the vessel in a volume upstream of the imaging volume, the magnetic labeling being preformed by means of an adiabatic flow criterion;
allowing time for the thus formed spin labeled moving substance to flow into said imaging volume; and
performing the acquisition of the thus formed spin labeled image in a plane comprising stationary and moving substances in the imaging volume, characterized in that the magnetic labeling is performed with dedicated magnetic labeling means invasively in a substantially continuous mode.

2. A method according to claim 1, characterized in that said method further comprising the steps of:
making a control image of the imaging volume without spin labeling; and
subtracting the image data of the spin labeled image from the control image.

3. A system for performing an acquisition of spin labeled images of an imaging volume of a vessel, said system comprising a magnetic resonance apparatus and magnetic labeling means to perform a magnetic labeling of spins of a moving substance in the vessel in a volume upstream of the imaging volume, the magnetic labeling being performed by means of an adiabatic flow criterion, characterized in that the magnetic labeling means are dedicated invasive means.

4. A system according to claim 3, characterized in that the magnetic labeling means comprise an elongated magnetic resonance imaging probe, said probe to be introduced in the vessel, said magnetic resonance imaging probe comprising an RF-transmit coil and further magnetic means arranged for inducing a local stationary magnetic gradient field in a volume comprising said RF-transmit coil, said gradient field being substantially parallel to a longitudinal direction of the magnetic resonance imaging probe.

5. A magnetic resonance imaging probe to be used in a system according to claim 4, characterized in that the further magnetic means comprise at least one permanent magnet.

6. A magnetic resonance imaging probe to be used in a system according to claim 4, characterized in that the further magnetic means comprise a material having a magnetic susceptibility that is substantially different from a magnetic susceptibility of a surrounding medium in the vessel.

7. A magnetic resonance imaging probe according to claim 5, characterized in that the magnetic resonance imaging probe further comprises an RF-receive coil, arranged to receive an imaging signal emanating from the imaging volume, said RF-receive coil being located distally from the RF-transmit coil in the longitudinal direction of said magnetic resonance imaging probe.
